(19) United States
(12) Patent Application Publication
(10) Pub. No.: US 2013/0332001 A1
(43) Pub. Date: Dec. 12, 2013

(54) SYSTEM AND METHOD FOR DETECTING A POWER SOURCE AND METERING POINTS OF A NETWORK DEVICE IN A NETWORK ENVIRONMENT

(71) Applicants: John D. Parello, Campbell, CA (US); Brock A. Miller, San Francisco, CA (US); Luis O. Suau, Davie, FL (US); Antony John Harvey, Houston, TX (US)

(72) Inventors: John D. Parello, Campbell, CA (US); Brock A. Miller, San Francisco, CA (US); Luis O. Suau, Davie, FL (US); Antony John Harvey, Houston, TX (US)

(73) Assignee: Cisco Technology, Inc.

(21) Appl. No.: 13/492,617

(22) Filed: Jun. 8, 2012

(51) Int. Cl. G06F 1/26

(52) U.S. Cl. 700/295

(57) ABSTRACT

A method is provided in one example embodiment and includes sending a first message from a controller to a particular network device. The message causes the particular network device to modulate its power and to generate a power signature. The method also includes receiving a second message that is indicative of the power signature being detected, the second message is an acknowledgment message that includes an identification of the particular network device. The power signature can be detected by any number of components such as a power source, a power outlet, a metering point.

### TECHNICAL FIELD

This disclosure relates in general to the field of energy and, more particularly, to a system and a method for detecting a power source and metering points of a network device in a network environment.

### BACKGROUND

Energy consumption has become a preeminent concern for industrialized societies. Both consumers and businesses have become aware of their energy usage. Whether motivated by altruistic reasons, or by profitability concerns, individuals have come to terms with the notion that energy is a finite commodity; a commodity having accompanying costs that should be managed. Administrators now focus on power usage and, more specifically, on how to reduce those expenditures. In recent times, device manufacturers have added instrumentation and features in networks to quell these concerns.

Management of network devices may include monitoring an energy source and the power usage of electrical equipment. Meters may be placed at power distribution points to summarize energy usage and the sources of energy may also provide metering of energy. As network systems have become more sophisticated, while power demands have continued to increase, architectures continue to fail in matching network capabilities with more intelligent energy consumption. For example, often it can be difficult to determine the power source of a network device. It can also be difficult to identify which network devices are being monitored by an electrical meter.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of an energy management system in accordance with one embodiment of the present disclosure;

FIG. 1B is a simplified block diagram of an energy management system in accordance with one embodiment of the present disclosure;

FIG. 2 is a simplified block diagram illustrating possible example details associated with one embodiment of the present disclosure;

FIG. 3 is a simplified block diagram illustrating possible example details associated with one embodiment of the present disclosure;

FIG. 4 is a simplified block diagram illustrating possible example details associated with one embodiment of the present disclosure;

FIG. 5 is a simplified block diagram illustrating possible example details associated with one embodiment of the present disclosure;

FIG. 6 is a simplified block diagram illustrating possible example details associated with one embodiment of the present disclosure;

FIG. 7 is a simplified block diagram illustrating possible example details associated with one embodiment of the present disclosure; and

FIG. 8 is a simplified flow diagram illustrating potential operations associated with one embodiment of the present disclosure.

### DETAILED DESCRIPTION OF EXAMPLE EMBODIMENTS

### Overview

A method is provided in one example embodiment and includes sending a first message from a controller to a particular network device. The message causes the particular network device to modulate its power and to generate a power signature. The method also includes receiving a second message that is indicative of the power signature being detected, the second message is an acknowledgment message that includes an identification of the particular network device. The power signature can be detected by any number of components such as a power source, a power outlet, a metering point.

The method can also include broadcasting a third message to a domain that includes the particular network device, where the third message is indicative of a discovery activity being in progress. The method can also include generating an electrical topology mapping based on a plurality of signatures associated with a plurality of network devices, and communicating a plurality of messages to a subset of the plurality of network devices in order to shift from one power state to another power state in each of the subset. The power signature can include a signature duration, a low threshold power value for the particular network device, and a high threshold power value for the particular network device.

### Example Embodiments

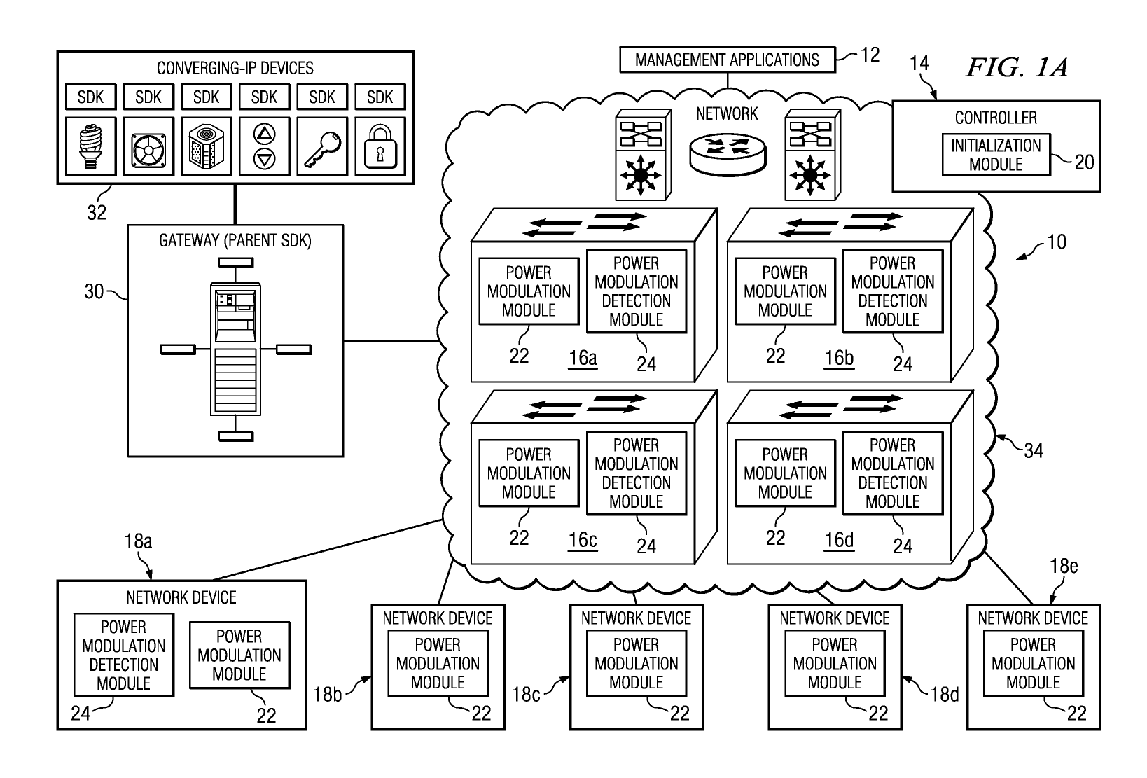

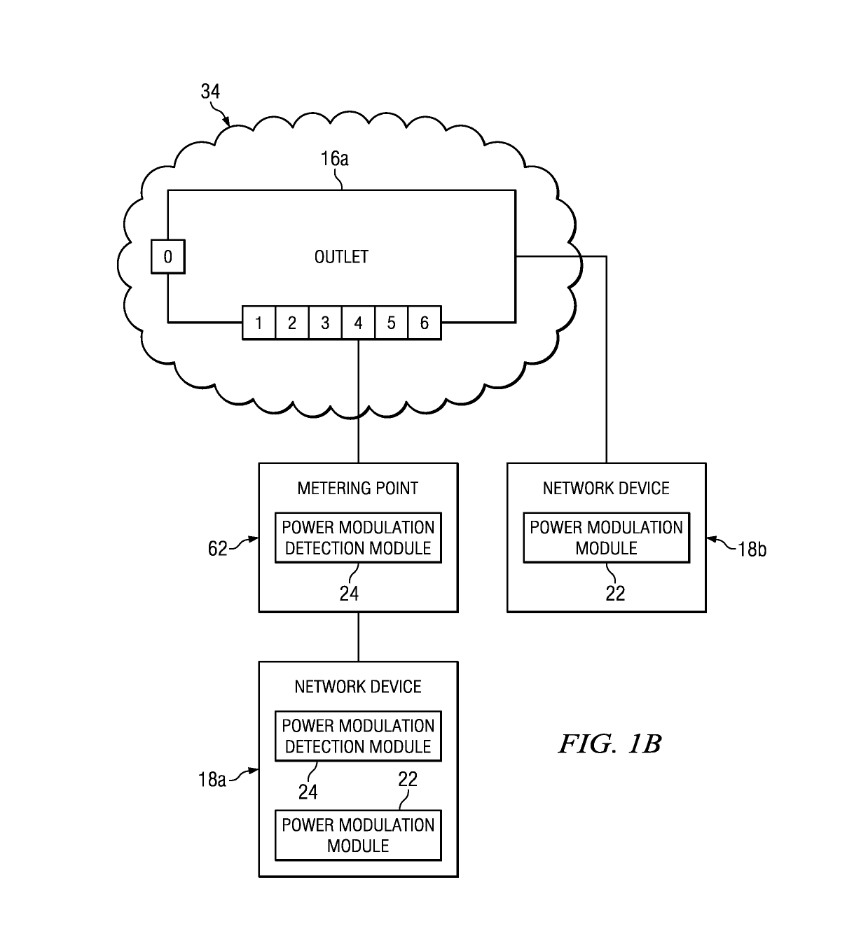

FIG. 1A is a simplified block diagram of an energy management system 10 in accordance with one example implementation of the present disclosure. FIG. 1A includes management applications 12, controller 14, a plurality of outlets 16a-d, a plurality of network devices 18a-e, a gateway 30, a plurality of converging internet protocol (IP) devices 32, a network 34, and a metering point 62. Controller 14 may include an initialization module 20. In certain example scenarios, one or more management stations of energy management system 10 (e.g., controller 14) can be configured to instruct a given network device to fluctuate its power given a certain power signature. For example, controller 14 can broadcast (to an entire domain) a power signature and, further, instruct any device that detects that power signature to respond back with an indication that it is powering the endpoint. For example, given an energy management domain, a given controller that is capable of broadcasting within a domain, and components capable of providing power via outlets to a set of 1-to-N endpoints (which are examples of network devices), a power discovery signature can be used to intelligently control power using network communications.

In one particular example, a power discovery signature can include an ID of a given endpoint, a signature duration (e.g., in milliseconds (ms)); a number of measures in a signature; a duration between measures (e.g., in ms); an array of beats of [e.g., 0, 1] values representing low/high thresholds; and low and high threshold values in watts for a particular domain, a particular endpoint, a particular set of endpoints, etc. Controller 14 may send a collect query for a ‘discover power signature’ to endpoints, where the endpoints can respond with a signature that is unique to the endpoints. Additionally, controller 14 can broadcast a discovery in progress for a signature to the domain. In certain example scenarios, if a particular power outlet detects a signature for a given endpoint, then it will respond to controller 14 with an acknowledgment (e.g., an ACK message) containing the ID of the outlet and the endpoint. Subsequently, controller 14 can send a set query “powered by” to the outlet and/or the endpoint. Additional details associated with these activities are discussed below in the context of several examples.

Referring back to FIG. 1A, each outlet 16a-d can include a power modulation module 22 and/or a power modulation detection module 24. Each network device 18a-e can include power modulation module 22 and/or power modulation detection module 24. Each outlet 16a-d may be a wall outlet, a power distribution unit (PDU) outlet, a power over Ethernet (POE) interface, a bus line (e.g., DC bus line), an electrical interface, a metering point, or any other suitable power source, or power connection.

Controller 14 can be provisioned in network 34 to execute some of the power management activities discussed herein. Each outlet 16a-d may contain multiple outlets designed to meter and/or to distribute electric power. Further, each outlet 16a-d can meter and/or control the output power of one or more network devices 18a-e (e.g., personal computers (PCs), building controllers, wireless devices, telephones, lighting fixtures, HVAC systems, video devices (e.g., Telepresence systems), etc.). Each network device 18a-e can interact with one outlet 16a-d. Certain network devices 18a-e may be associated with IP devices having corresponding Software Development Kit (SDK) elements. Similarly, gateway 30 may operate as a parent SDK for its child endpoints (e.g., converging-IP devices 32). Management applications 12 can operate to intelligently control (directly or indirectly) any of the devices of FIG. 1A.

Turning to FIG. 1B, FIG. 1B is a simplified block diagram of energy management system 10 in accordance with one example electrical topology implementation of the present disclosure. FIG. 1B includes outlet 16a, network devices 18a and 18b, network 34, and a metering point 62. Metering point 64 includes power modulation detection module 24. Metering point 62 can meter the power to network device 18a. While not shown, a metering point may also meter the power to network device 18b (or one or more network devices 18c-e). Network device 18a is shown being powered by a “smart” socket 4 (or switch 4) of outlet 16a that can meter the power to network device. In another embodiment, network device 18b is powered by outlet 16a and outlet 16a may or may not be a “smart” outlet. By modulating the power of outlet 16a, network device 18a, and/or metering point 62, the electrical topology of energy management system 10 can be, at least, partially mapped.

In general terms, energy management system 10 can measure and monitor power for network devices 18a-e (phones, AP's, PCs, building systems, etc.) and, further, provide command and control for network devices 18a-e. For example, the activities of energy management system 10 may include communicating messages to individual network devices 18a-e for shifting from one power state to a different power state. From a business perspective, the smart loading capabilities of the architecture allow for realizable cost savings.

Furthermore, energy management system 10 can provide a mechanism that understands the power consumption characteristics of network devices 18a-e for which it has responsibility. This can include understanding which outlet 16a-d can interact with each network device 18a-e. In essence, the network can operate as a control plane for controlling the energy consumption/usage for one or more network devices 18a-e. In this sense, the network serves as a platform for energy control.

In one example, energy management system 10 can automatically associate a powered endpoint (e.g., network device 18a) with an outlet (e.g., outlets 16a-d) to which the powered endpoint (e.g., network device 18a-e) is connected. More specifically, controller 14 may instruct network device 18b to fluctuate its power and/or give a specific artificial power signature (e.g., a specific modulated output power). In this sense, the term ‘modulate’ is broad and, therefore, includes any type of power fluctuation, power output, or power characteristic that can be generated by a given network device. In certain cases, the modulation may be preprogrammed into the network device, or be predefined, or be part of some sort of factory setting specific to the network device, or be provisioned in some sort of event or update, or be part of a response in reaction to a command or message issued by controller 14. Controller 14 can then broadcast the specific power signature to devices with power modulation detection module 24 (e.g., outlets 16a-d and network device 18a). Any device that detects the specific power signature can conclude that it is powering and/or metering the endpoint. Note that in certain embodiments, the activities of the present disclosure are different than detecting a device's natural output power signature because a specific non-natural power signature is being created for the device.

For purposes of illustrating certain example techniques of energy management system 10, it is important to understand how energy management system 10 provides command and control functions for network devices 18a-e. The following foundational information may be viewed as a basis from which the present disclosure may be properly explained. Such information is offered earnestly for purposes of discussion only and, accordingly, should not be construed in any way to limit the broad scope of the present disclosure.

The architecture of energy management system 10 can allow for the management of network devices (e.g., personal computers (PCs)) connected to switches, wireless access point, etc. using the network to monitor, control, and (ultimately) save energy. One driver behind the initiative is the ability to issue, distribute, and deliver change power state requests (e.g., wake-on-LAN messages) throughout energy management system 10. Energy management system 10 can query for power information using the network. However, before energy management of a network device can be achieved, the power source (e.g., outlet) that is metering the network device should be determined.

The controller itself can be any network device, network node, or network element that can communicate using the network. Controller 14 can maintain any number of data sets (e.g., tables, lists, policies, etc.) that can be used in the management of the architecture. For example, the data can reveal a given network device's identification or ID, the network device's role, the domain of the network device, the importance of the network device, the current state of the network device, a respective management interface for the network device, any keywords or filter criteria associated with the network device, what outlet is metering the network device, etc.

Once the electrical topology is mapped (i.e., the power source for each device (e.g., network devices 18a-e) has been detected), power policies can be sent to each power source (e.g., outlet 16a-d and/or metering point 62). The actual ‘mapping’ can be a simple table, a list, a database entry, or a graphical illustration (e.g., rendered on a graphical user interface (GUI), for example). Furthermore, the policies can be propagated to individual network devices (e.g., network devices 18a-e). For example, a policy could be propagated to each outlet 16a-d that indicates to shut down certain inactive phones, or to hibernate periphery equipment in a building at 8 PM. Another example could involve moving HVAC systems to certain levels after the workday has concluded. Another example could involve switching to a hibernation state for all PCs during a lunch hour (e.g., 12 PM-1 PM).

Additionally, with the electrical topology mapping, energy management system 10 can identify peak power times in smoothing or time shifting the power usage in a given environment. For example, a management application can monitor power consumption and receive a peak power alert. A policy can be created to minimize this peak consumption by leveraging/distributing power states across a given domain. Part of this policy may include identifying eligible phones, laptops, and building HVAC systems that could be candidates for shifting to a low power state or a hibernation state. For example, in the context of the identified devices, a laptop could move to hibernation, eligible phones could also move to a low power state, printers could move to a sleep mode or hibernation state, etc.

In one example implementation, controller 14 can include software to facilitate energy management operations. For example, controller 14 may include software that is configured to intelligently evaluate an opportune time for sending broadcast messages to the network devices for switching between power states. In example embodiments, network access can be leveraged to offer the capability for an end user to control energy parameters in a given domain. Note that controller 14 can readily be part of a server in certain embodiments of this architecture, or provisioned in conjunction with management applications 12.

In one particular example, certain items or elements can be provisioned for the intelligent energy management system to function. For example, outlets 16a-d can include an agent (for example, in software) that allows outlets 16a-d to respond to broadcast messages from the network (e.g., a broadcast message to switch between power states or to detect a specific power signature). Note that the term ‘broadcast message’ as used herein in this Specification is meant to encompass any type of signaling, packet information (e.g., transmission control protocol/internet protocol (TCP/IP), user datagram protocol (UDP) communications), proprietary messaging, short message service (SMS) communications, instant messaging (IM), e-mail protocols, or any other message type that can be delivered to an outlet. In still other embodiments, the energy management features may be provided externally to controller 14, outlets 16a-d, and/or network devices 18a-e, or included in some other network device, or in a computer to achieve these intended functionalities.

In more specific implementations, the system can allow network and network-attached equipment to take advantage of a configuration that includes no central processing and no central repository. This also offers the advantage of having no single point of failure. The group in the cloud (i.e., the network) is self-managed, where there is no central control. Further, the configuration of energy management system 10 is protocol agnostic and virtually any communication transport can be used. The system allows cloud computing to be done to a variable number of entities (all of which may have different types of ASICS, OSs, etc.). Dynamically, the endpoints (i.e., network devices 18a-e) join and leave the heterogeneous environment, where various types of devices can be managed by energy management system 10. As endpoints join the heterogeneous environment, the power source metering for each endpoint can be determined.

Energy management system 10 enables businesses to monitor and to control the electric consumption of networking equipment. An administrator can monitor devices like switches and routers, as well as LAN switch connected Power over Ethernet (PoE) devices like phones, access points, IP security cameras, door access equipment, etc. Energy management system 10 also has the ability to monitor and to control power of AC powered devices like smart power distribution units, networked building systems, and office equipment. Energy management system 10 also includes an open interface to allow third party management systems to participate in the framework. This simplifies integration of power reporting and automation into existing business practices.

Briefly discussing some of the possible activities to be accommodated by the architecture, the system can leverage a simple network management protocol (SNMP) and so sure a secure socket layer (SSL) protocol to execute some of the messaging functions of example embodiments. The management applications can be tailored for particular facilities or for specific IT scenarios. Switches and routers can readily communicate through the management API, where the network can aggregate status and power information. In terms of a client protocol, this element can communicate status and receive policies.

In operation, energy management system 10 can be configured to communicate a broadcast message that requests a shift from one power state to another power state. This broadcast message can be triggered in cases based on specific policies, on administrator preferences, on cost considerations, etc. Consider an example campus network deployment where users are not using their network devices 32 (e.g., at night). If a message is received for network devices to enter into low power state (e.g., a message indicating network devices 18a-e should enter into a hibernation state), a broadcast message can be communicated to each network device 18a-e or each outlet 16a-d that controls each network device 18a-e. The broadcast message may request/instruct the network devices 18a-e to shift from a normal operating state to a hibernation state or for each outlet 16a-d to reduce the power sent to each network device 18a-e. This would reduce the power consumed.

The messages can be sent to all network devices 18a-e and/or outlets 16a-d, to selected network devices 18a-e and/or outlets 16a-d, to selected groups of network devices 18a-e and/or outlets 16a-d, etc. in order to instruct them that they should switch power states. In one particular example, network devices 18a-e and outlets 16a-d are adapted to interpret the broadcast messages such that network devices 18a-e can readily switch power states. In certain implementations, the broadcast messages received by network devices 18a-e and outlets 16a-d can include an assigned time interval for the network devices 18a-e to remain in the power state. Additional instructions can indicate particular states for transitioning from the power state (e.g., transitioning to a normal operating state after being in a hibernation state).

The management application (e.g., provisioned within controller 14) can communicate with designated network devices 18a-e and outlets 16a-d using various communication protocols. In one example, the communication is delivered over a wired network. In other instances, a wireless access point can deliver the communication wirelessly via management frames in a corresponding 802.11 message. Note that in particular use cases, an Energy Efficient Ethernet protocol (e.g., IEEE 802.3az) can be involved in such messaging. Other protocols can include proprietary mechanisms, unicasting activities, multicasting activities, simple TCP/IP communications, UDP communications, any appropriate discovery protocol, etc.

In one example operation, demand response broadcast messages instruct the devices to shift into different power states. In particular implementations involving personal computers, the broadcast message includes a Windows™ PowerCfg command, which instructs a network device 18a-e to switch power states. Moreover, existing protocols in network devices 18a-e can be used as a mechanism to affect the power state change. For example, ‘Desktop and mobile Architecture for System Hardware’ (DASH) and vPro (e.g., in Intel environments) can be leveraged to achieve this activity. In other instances, Windows Management Instrumentation (WMI) could be leveraged for the change. WMI is simply an API in the Windows operating system that enables devices and systems in a network (e.g., typically enterprise networks) to be managed and controlled. Often utilizing common information model (CIM), WMI allows network administrators to query and manage workstations, applications, networks, etc.

Operationally, network devices 18a-e can enter into a different power state based on any number of potential options. For example, one option may be associated with a timeout message provided in the request to switch power states. The message may indicate, for example, to switch to a hibernation state for the next four hours. Another option would involve a second message sent for network devices 18a-e to enter into a new power state (e.g., an operating power state after being in a hibernation state). Still other options can involve default-timing mechanisms (specific to each network device 18a-e) such that network devices 18a-e can automatically shift to their normal power state after some predefined time interval (e.g., 60 minutes, etc.).

Note that certain infrastructure may be aware of whether network devices 18a-e have the option of changing power states. For example, the outlet to which network devices 18a-e are connected, may know that each network device 18a-e has several different power states that each network devices 18a-e could enter into. Other mechanisms for knowing (ahead of time) the power state options of network devices 18a-e can involve simple provisioning by administrator, discovery mechanisms when network devices 18a-e come online, querying activities involving individual network devices 18a-e, etc. The different power states may include a normal operating power state, a reduced or low power state, a hibernation power state, etc.

In regards to the management API for management applications 12, there can be several methods for a management application to communicate with the network (e.g., SNMP, SSL, etc.). A management information base (MIB) can be available on each enabled network device and can include power usage, power policy, alarms, etc. The MIB can provide per-device information. Network management systems interested in a network-wide query can use the SSL interface. The SSL interface can allow a single switch to query/set information from/to all switches in a domain.

In terms of example messaging protocols, query events can be used to retrieve information (i.e., power usage, etc.) from endpoints. The transport protocol for events can be a user datagram protocol (UDP) in one example, but this protocol is configurable such that it can accommodate other transport protocols (e.g., TCP). Queries within the network can be delivered hop-by-hop via neighbors, encrypted using a shared secret, or provisioned using other alternative to communication mechanisms.

Actions can be taken for each query (or event). The base code can be used to dictate the power actions. However, each individual vendor can configure his own device based on particular needs. For example, the printer could interpret Level 11 as a “Full Power” for the Hewlett Packard 5600 Series Printer and Level 2 as a “Standby” mode. In this sense, the translation of what to do [based on some event] is somewhat proprietary and can be defined by each manager of the device.

One aspect of example implementations of the present disclosure addresses a plug-in method for normalizing devices. Energy management system 10 can define a method for allowing the interface to be translated into other interfaces that may exist on devices. For example, older protocols like BACNET or SNMP can be leveraged. This allows the architecture to normalize the heterogeneous devices on the network. Another aspect of example implementations of the present disclosure involves the actual query mechanism, which could involve a distributed query processor. In one example implementation, devices in the domain maintain a listing of their connected neighbors. The architecture can forward queries from any member in the domain to all members of the domain. This allows the entire domain to be viewed as one device.

More specifically, once the system has a domain of entities that are tracking their attributes, the system can readily communicate with the entities. There are various types of communication messages: an entity connecting to the network (Discovery); one entity notifying the others in the domain about significant changes (Event); asking for information from one or more entities (Query); and setting information on one or more entity (Query). The system can define an event format that the system can use as the base for all communications.

In one example implementation, communication between entities of energy management system 10 is done via an event framework. The system can have a generalized event format, where the system can use that for basic notifications. The system can then have subsets of events that the system uses for discovery and queries. The format of the event can be at the classic application level, independent of the transport method in one example embodiment. The transport protocol used for event delivery can be neutral.

One example implementation involves using a discovery protocol (DP) and a link layer discovery protocol (LLDP) for transporting events regarding entities that connect or disconnect from the network. The system can use UDP (e.g., encrypted with the shared secret from the domain) for event delivery. Only entities in the domain with the correct shared secret can be able to decrypt and read the event in accordance with one example implementation. Note that there are many different products and customers with various deployment types. The transport protocol of the system should be neutral so that the system can support the wide variety of product and deployment types. In one example, the system can provide this specification over DP/LLDP and UDP leaving the implementation over other protocols as a development exercise. For deployment over the switching products, the system can make the transport protocol configurable.

In regards to queries, a general power query (PQR) can be implemented in certain example implementations of the present disclosure. The system can offer a mechanism of communicating with one, some, or all entities in a domain. Note that the system can communicate with one or more entities at a single moment in time, while not relying on a central server to provide this feature. The system has specific and global control over the entities. The system can also get or set information from one or many entities and adjust the usage for one entity or perhaps tell an entire group of entities to set to a specific level. Asking for, or setting information, on an entity can be done via a query mechanism. In one example, the system broadcasts a query to the devices in the domain.

The system can use the PQR and the outlined response mechanisms for queries. The power query is a generic querying mechanism, which can ask entities for the value of some attribute, for example. Querying for power usage or something specific to an entity would be embodied in such a query. For example, from any switch in the domain the system could be able to ask: What is your current usage? What is the current usage of the entire domain? What is the usage for a subset of the domain?

The PQR mechanism can allow the system to view the domain as a group of entities and communicate with one or all of the entities. The system can send a query as a point-to-point query or as a logical broadcast to the entities. The PQR feature will [through discovery events, neighbor tables, and the algorithms implemented on the supporting entities], provide a query service that logically resembles a broadcast to devices and a natural reply to the sender. Whenever an entity asks for information, the system can send an event. If the event is addressed to a specific entity, that entity alone can reply to the event. If it is sent to more than one entity, each entity can reply if appropriate, and then forward the event to its neighbors. The sender of the request can specify if they would like the replies collected or summed as a response.

For example, the system could query all switches, ask for their usage, and get a list of IDs and usage (Collect). The architecture of the present disclosure could also ask for usage of switches and get a reply that is one number: representing the sum of the usages (Sum). Moreover, the system offers the ability to issue these queries from any switch (or device) in the domain. The PQR allows the architecture the present disclosure to view the entire network as one entity, or as many entities.

In regards to the discovery for query propagation, the system can use DP and LLDP to identify an entity joining a domain. A device implementing the energy protocol can report their connection to the network via DP/LLDP in one example embodiment. These devices can send a discovery event over DP/LLDP that identifies them as part of a domain. The event can also contain appropriate version information so the system can know what release of the protocol the entity is implementing. DP/LLDP can be used for physically connected entities. The system can also use UDP broadcast as well as DP/LLDP broadcast when an entity connects to the system. This can allow network and physically connected entities to maintain neighbor connections. Entities can maintain neighbor information gathered from the discovery.

In regards to policy setting via queries that recur, one of the ways the system can manage a network of entities is to specify a policy and let the entities themselves adjust according to the policies. A policy is a way of telling an entity to adjust according to some criteria (time, for example). This could allow all networked devices in branch offices going to a standby mode at 8 pm and then moving back to full power levels at 7 AM.

The architecture of the present disclosure can view policies as simply events that recur. Thus, the system can send out an event that instructs one or more entities to set to ‘Level Standby’ and, further, specify the recurrence of that event. Any entity receiving the event can act on the event at the times specified by the recurrence (e.g., until cancelled). On a related note, by combining the proxy features of a parent and the ability to send recurring events, a non-compatible device could ask a parent to act on its behalf with a recurrence. In one example implementation, some type of management application element can send an event to a parent switch and ask for it to set its level at recurring times. In this way, the system can implement policies for entities from a compatible switch. Given the query concepts outlined above, the system has a language for asking the network for information or asking it to set to a state.

The plug-in type model allows the system to proxy legacy power controlling devices, where their values are added to the computation, which gives a normalized view of the network. The query method of the system allows for processing values from a network: much like a set of equation summations for a network view of power settings and changes. Use of an importance calculation allows the system to combine a unique query mechanism with the importance calculation to express power settings with the context for which they are deployed.

In response to an Energy Management Protocol.QUERY.INVENTORY, all receivers can respond with a payload of Energy Management Protocol_NEIGHBOR_COUNT and Energy Management Protocol_NEIGHBORS. This could be sent out by entities wishing to notify changes no reply is necessary. Receivers act upon the event as dealer's choice. Any change to importance can be sent as an update. Upon receipt of a query, the entity can respond with an ACK. WILL indicates the query can be honored and a value returned. WILL NOT indicates the query did not apply to the receiver because of priority/importance conflicts. If the domain does not match, then there is no reply.

Discovery and KEEP ALIVES can be processed with no ACK required. For the DP/LLDP mechanism, when a device starts and connects as part of its normal DP processing it should send an Energy Management Protocol.DISCOVERY.UPDATE event to its neighbors. In response, the receivers should update their neighbor tables and return the receivers Energy Management Protocol.DISCOVER.UPDATE event.

Turning to the example infrastructure associated with present disclosure, network devices 18a-d can be associated with devices, customers, endpoint, or end users wishing to receive data or content in energy management system 10 via some network. The term ‘network device’ is inclusive of devices used to initiate a communication, such as a receiver, a computer, a set-top box, an Internet radio device (IRD), a cell phone, a smart phone, a tablet, a personal digital assistant (PDA), a Google droid, an iPhone, an endpoint, an iPad, or any other device, component, element, or object capable of initiating voice, audio, video, media, or data exchanges within energy management system 10. Content receivers 18a-d may also be inclusive of a suitable interface to the human user, such as a display, a keyboard, a touchpad, a remote control, or other terminal equipment. Data, as used herein in this document, refers to any type of numeric, voice, video, media, or script data, or any type of source or object code, or any other suitable information in any appropriate format that may be communicated from one point to another.

Network 34 represents a series of points or nodes of interconnected communication paths for receiving and transmitting packets of information that propagate through energy management system 10. Network 34 offers a communicative interface between sources and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. A network can comprise any number of hardware or software elements coupled to (and in communication with) each other through a communications medium.

In one particular instance, the architecture of the present disclosure can be associated with a service provider digital subscriber line (DSL) deployment. In other examples, the architecture of the present disclosure would be equally applicable to other communication environments, such as an enterprise wide area network (WAN) deployment, cable scenarios, broadband generally, fixed wireless instances, fiber to the x (FTTx), which is a generic term for any broadband network architecture that uses optical fiber in last-mile architectures, and data over cable service interface specification (DOCSIS) cable television (CATV). The architecture of the present disclosure may include a configuration capable of TCP/IP communications for the transmission and/or reception of packets in a network.

Controller 14, outlets 16a-d, network devices 18a-d, and metering point 62 are network devices that can facilitate the power source detecting activities discussed herein. As used herein in this Specification, the term ‘network device’ is meant to encompass any of the aforementioned elements, as well as routers, switches, cable boxes, gateways, bridges, loadbalancers, firewalls, inline service nodes, proxies, servers, processors, modules, or any other suitable device, component, element, proprietary appliance, or object operable to exchange information in a network environment. These network elements may include any suitable hardware, software, components, modules, interfaces, or objects that facilitate the operations thereof. This may be inclusive of appropriate algorithms and communication protocols that allow for the effective exchange of data or information.

In one implementation, controller 14, outlets 16a-d, network devices 18a-d, and/or metering point 62 can include software to achieve (or to foster) the power source detecting and/or metering activities discussed herein. This could include the implementation of instances of initialization module 20, power modulation module 22, and/or power modulation detection module 32. Additionally, each of these elements can have an internal structure (e.g., a processor, a memory element, etc.) to facilitate some of the operations described herein. In other embodiments, these power source detecting activities may be executed externally to these elements, or included in some other network element to achieve the intended functionality. Alternatively, controller 14, outlets 16a-d, network devices 18a-d, and/or metering point 62 may include software (or reciprocating software) that can coordinate with other network elements in order to achieve the power source detecting activities described herein. In still other embodiments, one or several devices may include any suitable algorithms, hardware, software, components, modules, interfaces, or objects that facilitate the operations thereof.

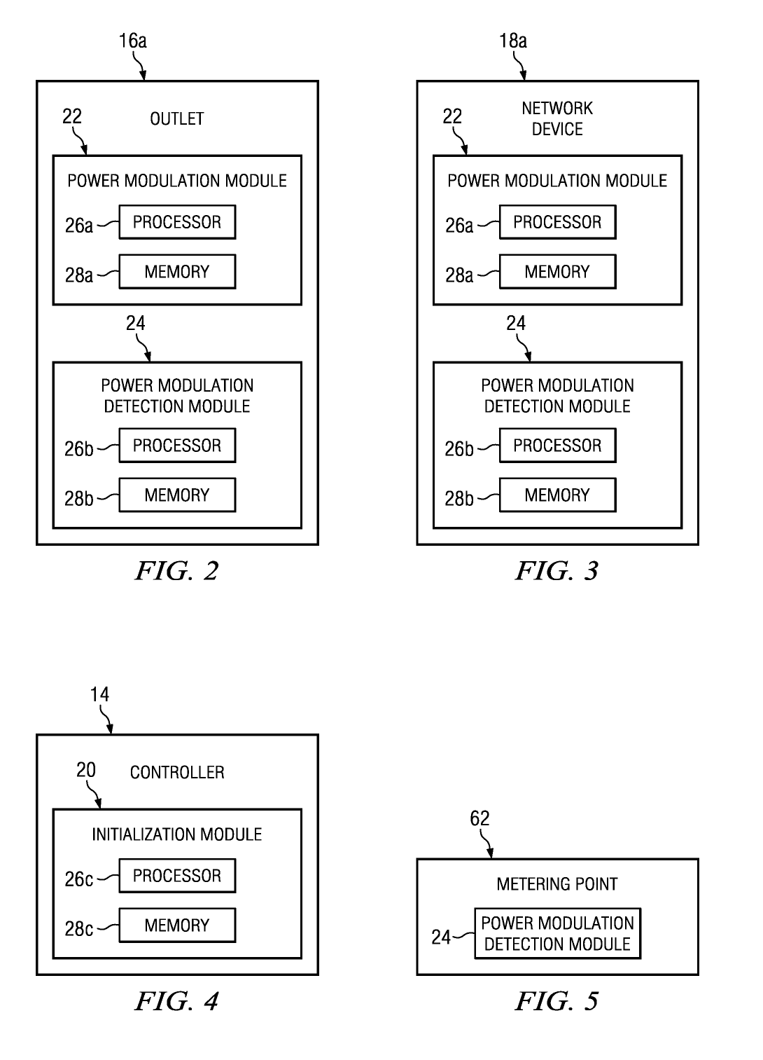

Turning to FIG. 2, FIG. 2 is a simplified block diagram illustrating one possible set of details associated with energy management system 10. FIG. 2 includes outlet 16a. Outlet 16a includes power modulation module 22 and power modulation detection module 24. Power modulation module 22 includes a processor 26a and a memory 28a. Power modulation detection module 24 includes a processor 26b and a memory 28b. In an example implementation, power modulation module 22 can receive a request from controller 14 to specifically modulate the power of a device (e.g., network device 18a) that is powered by outlet 16a. Power modulation detection module 24 can receive a message (e.g., a broadcast message from controller 14) to detect a specific modulated power from a device (e.g., from network device 18a or outlet 16a). If the specific modulated power is detected, then outlet 16a meters (and in an embodiment controls) the power for the device that has the specific modulated power.

Turning to FIG. 3, FIG. 3 is a simplified block diagram illustrating one possible set of details associated with energy management system 10. FIG. 3 includes network device 18a. Network device 18a includes power modulation module 22 and power modulation detection module 24. Power modulation module 22 includes processor 26a and memory 28a. Power modulation detection module 24 includes processor 26b and memory 28b.

In an example implementation, power modulation module 22 can receive a request from controller 14 to specifically modulate the power of network device 18a. Power modulation detection module 24 can receive a message (e.g., a broadcast message from controller 14) to detect a specific modulated power from a device (e.g., from network device 18b or outlet 16a). If the specific modulated power is detected, then network device 18a meters (and in an embodiment controls) the power for the device that has the specific modulated output power. For example, network device 18a may be a personal computer that meters and/or controls the power for several devices (e.g., television, coffee maker, microwave, etc.) in a residential home.

Turning to FIG. 4, FIG. 4 is a simplified block diagram illustrating one possible set of details associated with energy management system 10. FIG. 4 includes controller 14, which includes initialization module 20. Initialization module 20 may include a processor 26c and a memory 28c. Controller 14 is configured to send requests to a specific network device (e.g., network devices 18a-e) or a specific outlet (e.g., outlets 16a-d) to specifically modulate their power. In addition, controller 14 can send a message (e.g., a broadcast message) to each device that contains power modulation detection module 24 (or, in an embodiment, to devices in communication with controller 14) to detect the specific power modulation.

Turning to FIG. 5, FIG. 5 is a simplified block diagram illustrating one possible set of details associated with energy management system 10. FIG. 5 includes metering point 62. Metering point 62 is configured to meter the power of one or more network devices (e.g., network devices 18a-d). Metering point 62 includes power modulation detection module 24. Power modulation detection module 24 can receive a message (e.g., a broadcast message from controller 14) to detect a specific modulated power from a device (e.g., from network device 18b). If the specific modulated power is detected, then metering point 62 meters (and in an embodiment controls) the power for the device that has the specific modulated output power.

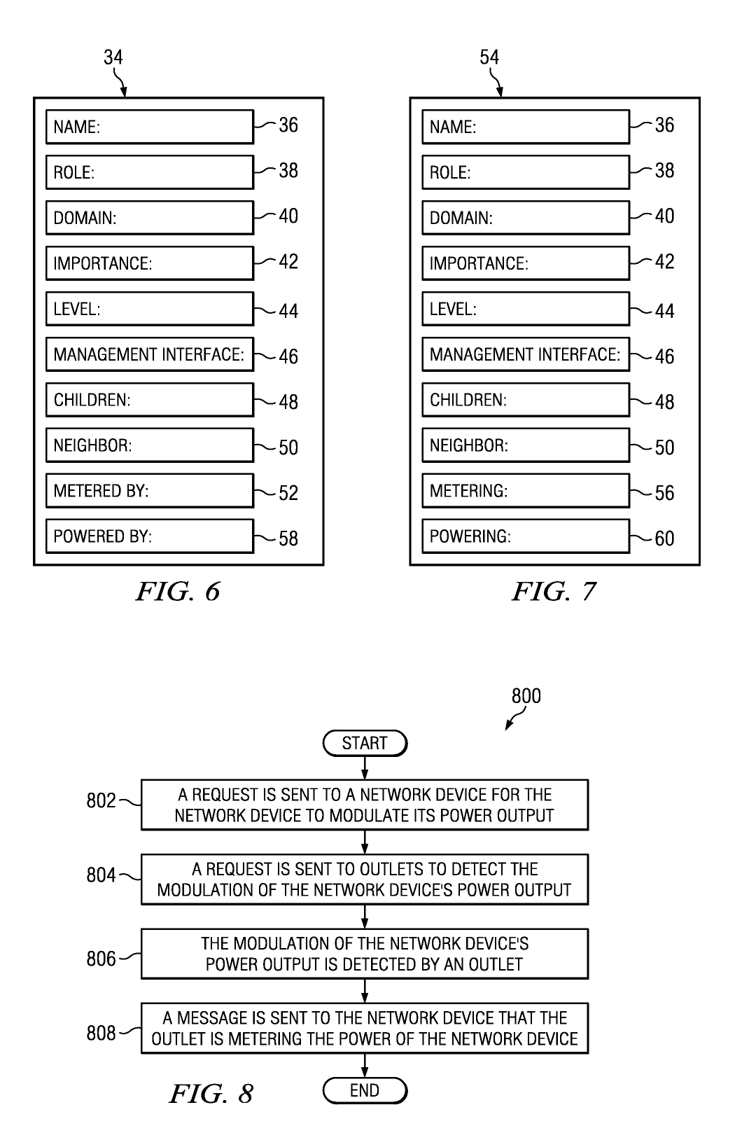

Turning to FIG. 6, FIG. 6 is a simplified block diagram illustrating one possible set of details associated with energy management system 10. FIG. 6 includes a data set 34. Data set 34 includes a name field 36, a role field 38, a domain field 40, an importance field 42, a level field 44, a management interface field 46, a children field 48, a neighbor field 50, a metered by field 52, and a powered by field 58. Name field 36 can include data that reveals a given device's (e.g., network device 18a) identification (ID). Role field 38 can include data regarding the device's role in energy management system 10. Domain field 40 can include data regarding the domain of the device. Importance field 42 can include data regarding the importance of the device. Level field 44 can include data regarding the device's current energy level. Management interface field 46 can include data regarding the device's respective management interface. Children field 48 can include data regarding respective children of the device. Neighbor field 50 can include data regarding possible neighbors of the device. Metered by field 52 can include data regarding what meters the device. Powered by field 58 can include data regarding what powers the device (e.g., outlet 16a).

Turning to FIG. 7, FIG. 7 is a simplified block diagram illustrating one possible set of details associated with energy management system 10. FIG. 7 includes a data set 54. Data set 54 includes name field 36, role field 38, domain field 40, importance field 42, level field 44, management interface field 46, children field 48, neighbor field 50, a metering field 56, and a powering field 60. Metering field 56 can include data regarding what devices are metered by a specific outlet. Powering field 60 can include data regarding what devices are powered by a device (e.g., if outlet 16a is powering network device 10a, then powering field 60 would identify network device 18a). In an embodiment data set 54 can also include metered by field 52 and/or powered by field 58.

Using data set 34 or data set 54, energy management system 10 can report power data in various forms, (e.g., reporting power per-wiring closet). In addition, there can be a summary of power per-switch or per-location. This would allow power and cost savings to be readily determined. Power policies can be sent to the network, where policies are propagated to individual outlets and/or network elements. For example, a policy could be propagated to building outlets and/or network elements that indicates to shut down all powered devices in the building at 8 PM. Thus, energy management system 10 can enable the creation of a domain of networked devices that can be power controlled.

FIG. 8 is a simplified flowchart 800 illustrating example activities of detecting the power source of a network element. At 802, a request is sent to a network device for the network device to modulate its output power. For example, controller 14 may send a request to network device 18b for network device 18b to modulate its output power. At 804, a request is sent to outlets to detect the modulation of the network device's output power. For example, controller 14 may send a request to outlets 16a-d and to network device 18a to detect the modulation of the output power for network device 18b. In this example, because network device 18a includes power modulation module 22, network device 18a may be configured to perform outlet functions and meter other network devices. At 806, the modulation of the network device's output power is detected by an outlet. For example, outlet 16a may detect the modulation of the output power for network device 18b. At 808, a message is sent to the network device that the outlet is metering the power of the network device. For example, outlet 16a may send a data set similar to data set 54 to network device 18b, thereby informing network device 18b that outlet 16a is metering the power of network device 18b. In an embodiment, outlet 16a may send a data set similar to data set 54 to controller 14, thereby informing controller 14 that outlet 16a is metering the power of network device 18b. In another embodiment, after learning that outlet 16a is metering the power of network device 18b, network device 18b may send a message similar to data set 34 to controller 14 informing controller 14 that outlet 16a is metering the power of network device 18b.

As identified previously, a network device (e.g., controller 14) can include software to achieve the energy management operations, as outlined herein in this document. In certain example implementations, the energy management functions outlined herein may be implemented by logic encoded in one or more tangible, non-transitory media (e.g., embedded logic provided in an application specific integrated circuit [ASIC], digital signal processor [DSP] instructions, software [potentially inclusive of object code and source code] to be executed by a processor [processors 26a and 26b shown in FIGS. 2 and 3 and processor 26c shown in FIG. 4], or other similar machine, etc.). In some of these instances, a memory element [memory 28a and 28b shown in FIGS. 2 and 3 and memory 28c shown in FIG. 4] can store data used for the operations described herein. This includes the memory element being able to store software, logic, code, or processor instructions that are executed to carry out the activities described in this Specification.

The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the energy management activities as outlined herein. Additionally, each of these devices may include a processor that can execute software or an algorithm to perform the energy management activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that energy management system 10 (and its teachings) are readily scalable and, further, can accommodate a large number of components, as well as more complicated/sophisticated arrangements and configurations. Accordingly, the examples provided should not limit the scope or inhibit the broad teachings of energy management system 10, as potentially applied to a myriad of other architectures.

It is also important to note that the steps in the preceding FIGURES illustrate only some of the possible scenarios that may be executed by, or within, energy management system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by energy management system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain protocols (e.g., UDP, SSL, SNMP, etc.), energy management system 10 may be applicable to other exchanges and protocols in which data are exchanged in order to provide energy management operations. In addition, although energy management system 10 has been illustrated with reference to particular elements and operations that facilitate the communication process, these elements and operations may be replaced by any suitable architecture or process that achieves the intended functionality of energy management system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
sending a first message from a controller to a particular network device, wherein the message causes the particular network device to modulate its power and to generate a power signature; and
receiving a second message that is indicative of the power signature being detected, wherein the second message is an acknowledgment message that includes an identification of the particular network device.

2. The method of claim 1, wherein the power signature is detected by a selected one of a group of components, the components consisting of:
a) a power source;
b) a power outlet; and
c) a metering point.

3. The method of claim 1, further comprising:
broadcasting a third message to a domain that includes the particular network device, wherein the third message is indicative of a discovery activity being in progress.

4. The method of claim 1, further comprising:
generating an electrical topology mapping based on a plurality of signatures associated with a plurality of network devices; and
communicating a plurality of messages to a subset of the plurality of network devices in order to shift from one power state to another power state in each of the subset.

5. The method of claim 1, wherein the first and second messages are propagated using a simple network management protocol (SNMP) and a secure socket layer (SSL).

6. The method of claim 1, wherein the power signature includes a signature duration, a low threshold power value for the particular network device, and a high threshold power value for the particular network device.

7. The method of claim 1, wherein the second message identifies a power source, a power outlet, or a metering point for the particular network device.

8. The method of claim 1, wherein the second message includes a list of network devices that are associated with a power source for the particular network device.

9. The method of claim 1, wherein the second message includes a list of network devices that are associated with metering of the particular network device.

10. Logic encoded in non-transitory computer readable media that includes instructions for execution and when executed by a processor, is operable to perform operations, comprising:
sending a first message from a controller to a particular network device, wherein the message causes the particular network device to modulate its power and to generate a power signature; and
receiving a second message that is indicative of the power signature being detected, wherein the second message is an acknowledgment message that includes an identification of the particular network device.

11. The logic of claim 10, wherein the power signature is detected by a selected one of a group of components, the components consisting of:
a) a power source;
b) a power outlet; and
c) a metering point.

12. The logic of claim 10, the operations further comprising:
broadcasting a third message to a domain that includes the particular network device, wherein the third message is indicative of a discovery activity being in progress.

13. The logic of claim 10, the operations further comprising:
generating an electrical topology mapping based on a plurality of signatures associated with a plurality of network devices; and
communicating a plurality of messages to a subset of the plurality of network devices in order to shift from one power state to another power state in each of the subset.

14. The logic of claim 10, wherein the first and second messages are propagated using a simple network management protocol (SNMP) and a secure socket layer (SSL).

15. The logic of claim 10, wherein the power signature includes a signature duration, a low threshold power value for the particular network device, and a high threshold power value for the particular network device.

16. The logic of claim 10, wherein the second message identifies a power source, a power outlet, or a metering point for the particular network device.

17. An apparatus, comprising:
a memory element for storing data; and
a processor that executes instructions associated with the data, wherein the processor and the memory element cooperate such that the apparatus is configured to:
send a first message to a particular network device, wherein the message causes the particular network device to modulate its power and to generate a power signature; and
receive a second message that is indicative of the power signature being detected, wherein the second message is an acknowledgment message that includes an identification of the particular network device.

18. The apparatus of claim 17, wherein the power signature is detected by a selected one of a group of components, the components consisting of:
a) a power source;
b) a power outlet; and
c) a metering point.

19. The apparatus of claim 17, the apparatus being further configured to:
broadcast a third message to a domain that includes the particular network device, wherein the third message is indicative of a discovery activity being in progress.

20. The apparatus of claim 17, the apparatus being further configured to:
generate an electrical topology mapping based on a plurality of signatures associated with a plurality of network devices; and
communicate a plurality of messages to a subset of the plurality of network devices in order to shift from one power state to another power state in each of the subset.
